(19) United States
(12) Patent Application Publication
(10) Pub. No.: US 2023/0015216 A1
(43) Pub. Date: Jan. 19, 2023

(54) AMBIENT SOUND EVENT DETECTION AND RESPONSE SYSTEM

(71) Applicant: Zinfanite Technologies, Inc., Torrance, CA (US)

(72) Inventors: Jana Mahen Fernando, Torrance, CA (US); Ali Reza Kharrazi, Rancho Cucamonga, CA (US)

(21) Appl. No.: 17/950,965

(22) Filed: Sep. 22, 2022

Related U.S. Application Data
(63) Continuation-in-part of application No. 17/477,819, filed on Sep. 17, 2021.
(60) Provisional application No. 63/080,954, filed on Sep. 21, 2020.

(51) Int. Cl. G06F 3/16; H04R 1/08; H04R 3/00; G10L 25/51; G01V 1/00

(52) U.S. Cl. CPC G06F 3/167; H04R 1/08; H04R 3/00; G06F 3/165; G10L 25/51; G01V 1/008

(57) ABSTRACT

A computer implemented method includes: capturing an ambient sound event; determining whether the ambient sound event matches at least one of a plurality of pre-identified sound events stored in a computer storage; generating a prompt via the user interface for a user to confirm that a response is needed; determining whether to initiate a response based on the user's response to the prompt.

### CROSS REFERENCE TO RELATED PATENT APPLICATION

This application is a continuation-in-part and claims the priority of U.S. patent application Ser. No. 17/477,819, filed on Sep. 17, 2021, which claims priority to U.S. Provisional Application No. 63/080,954, filed Sep. 21, 2020, the entirety of each application is hereby incorporated by reference.

### FIELD

This relates generally to electronic wearable devices, and more particularly, to an electronic wearable device incorporating an ambient sound event detection and response system.

### BACKGROUND

Electronic wearable devices are gaining popularity. They come in many shapes and forms. For example, headsets are designed to capture and play audio including voice calls. However, headsets and other existing forms of electronic wearable devices are not made to be customized especially as it pertains to their aesthetic look. The inability to customize the look of an electronic wearable makes it difficult to please the user's taste in all use cases and situations.

While many existing electronic devices can be used for making emergency calls, none provides active emergency monitoring and response based on ambient sound events. That is, existing electronic devices require a user-initiated action (e.g., pressing a button, dialing a number, providing a verbal confirmation) to activate their emergency notification capabilities. This is not ideal if the user is already unconscious or incapacitated to perform the action.

### SUMMARY

In one aspect, this disclosure relates to a wearable electronic device with an interchangeable faceplate. The wearable electronic device can function as a speakerphone. The wearable electronic device can incorporate an acoustic reflector for improving speaker sound quality.

In another aspect, this disclosure relates to an ambient sound event detection and response system. The system is capable of intelligently activating an emergency response in response to detecting and recognizing certain sound event with no or minimum user input.

### BRIEF DESCRIPTION OF THE DRAWINGS

FIG. 1 illustrates a base of an exemplary electronic wearable device, according to an embodiment of the disclosure.

FIG. 2a is a side view of a detachable faceplate of the exemplary electronic wearable device of FIG. 1, according to an embodiment of the disclosure.

FIG. 2b is a side view of a base of the exemplary electronic wearable device of FIG. 1, according to an embodiment of the disclosure.

FIGS. 3a-3c illustrate exemplary interchangeable faceplates that can be attached to the base of FIG. 1, according to embodiments of the disclosure.

FIG. 4 is a diagram illustrating the exemplary internal components of the base of an electronic wearable device illustrated in FIG. 1, according to an embodiment of the disclosure.

FIG. 5 is a diagram illustrating the exemplary components of a system of detecting sound and providing emergency responses, according to an embodiment of the disclosure.

FIG. 6 is a flow chart illustrating the exemplary steps in the process of capturing a sound event and producing a corresponding response, according to an embodiment of the disclosure.

### DETAILED DESCRIPTION OF THE PREFERRED EMBODIMENTS

In the following description of preferred embodiments, reference is made to the accompanying drawings which form a part hereof, and in which it is shown by way of illustration specific embodiments, which can be practiced. It is to be understood that other embodiments can be used and structural changes can be made without departing from the scope of the embodiments of this disclosure.

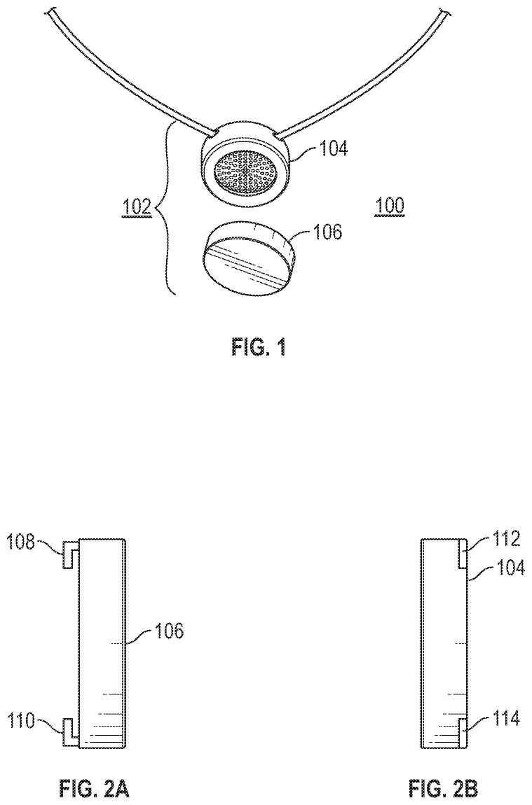

This disclosure generally relates to electronic wearable devices (or “devices” as referred to hereinafter). In one embodiment, as illustrated in FIG. 1, a wearable electronic device 100 that can be worn around the neck like a necklace attached with a pendant 102 is disclosed. The pendant 102 can include a base (or “base component”) 104 and a detachable faceplate 106. The base 104 can include the primary electronics that provide functions for the wearable device 100. The detachable faceplate 106 can be attached to the base 104 by any suitable mechanisms. In one example, as shown in FIG. 2a, the faceplate 106 can include two small clips 108, 110 on opposite ends. The clips 108, 110 can fit into corresponding openings 112, 114 on the base 104 shown in FIG. 2b. It should be understood that different number of clips can be used to attach the faceplate 106 to the base 104 and the location of the clips 108, 110 and openings 112, 114 on the faceplate and base, respectively, can be different from those shown in FIGS. 2a and 2b.

Other mechanisms can also be used. As example, the base 104 can be magnetic and the faceplate 106 can be metal (or vice versa) and the two can attach to each other magnetically. In one embodiment, the base (or the faceplate) may include a small magnetic ring along its outer edge. Alternatively, a magnet can be positioned in the center of the faceplate 106. As other examples, the faceplate 106 can be snapped or twisted on or off the base 104.

The base 104 and detachable faceplate can be made of waterproof material.

The base 104 includes the electronic components that provide various functions such as speakerphone functions. The faceplate 106 primarily serves for aesthetic purpose. In the embodiment of FIG. 1, the overall design of the device 100 can mimic the appearance of a necklace to increase the device's appeal to potential users. By allowing for an interchangeable faceplate 106 that can be detached easily from the base 104, the devices disclosed herein allow their wearers choose from an assortment of faceplate designs to give the device different looks.

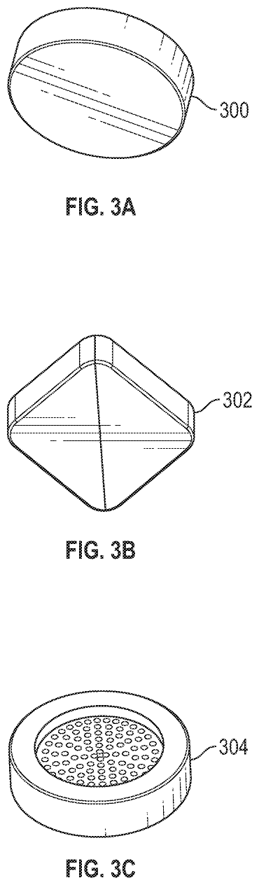

FIGS. 3a-3c illustrates various exemplary designs of the faceplate 106. For example, FIG. 3a illustrates a faceplate 300 in a circular shape. FIG. 3b illustrates a faceplate 302 in a diamond shape. FIG. 3c illustrates a faceplate 304 in an oval shape. It should be understood that the faceplate can be in any shape not illustrated in the figures. The faceplate can also be in different colors, sizes, be made of different material, and have different finishes such as metallic, ceramic, etc. In some embodiments, the faceplates can be designed to mimic a piece of jewel or a normal pendant so as to conceal the fact that an electronic device is hidden in the base behind it.

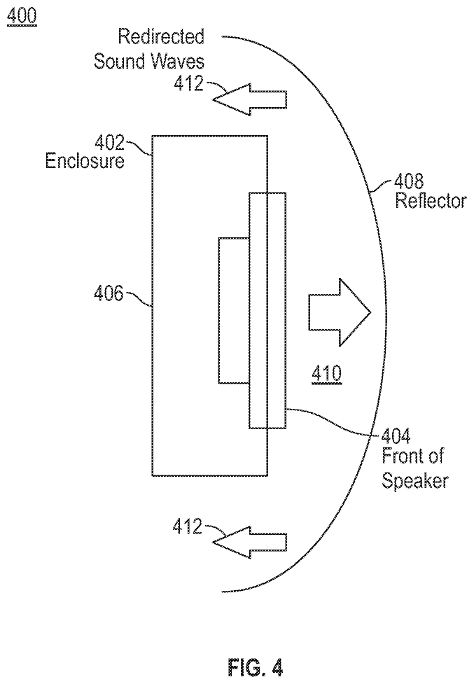

As mentioned above, the base 104 of the electronic wearable device 100 can include electronic components. In the embodiment illustrated in FIG. 4, the base 400 can be a speakerphone that includes a speaker enclosure 402 having a front end 404. The speaker enclosure 402 seals the speaker inside with one side of the speaker exposed to the exterior. This way, speaker enclosure 402 amplifies and helps the speaker emit sound. Generally, the face (i.e., front end) of the speaker is where most sound output is.

As illustrated in the figure, the front end 404, to which the faceplate (not shown in FIG. 4) is attached, faces the direction away from the wearer of the electronic wearable device. The backside 406 of the base 400 is against the chest of the wearer of the device when the device is worn like a necklace. This can create a problem in that the wearer of the device may not hear the sound from the speaker 402 clearly as the sound is transmitting in the direction 410 away from him.

In the embodiment illustrated in FIG. 4, a reflector 408 with a concave surface facing the front of the speaker 406 is positioned in front of the front end of the speaker 404. The reflector 408 can be made of sound deflecting material. Sound coming from the speaker 402 is reflected by the reflector 408's concave surface in the opposite direction 412 towards the wearer (not shown in FIG. 3) rather than away from the device into open space. The reflector 408 is designed and shaped to direct sound in an optimal direction that maximizes volume to the wearer. This allows the wearer to hear the sound more clearly while wearing the device. It should be understood that the reflector's sound reflecting surface can be of any shape and/or have any curvature based on the intended direction of the reflected sound from the speaker. The reflecting surface does not need to be symmetrical. Although the direction 412 shown in FIG. 1 appears to be directly toward the back of the speaker 402, it should be understood that the reflector 408 can be designed to reflect or deflect the sound in any direction.

The same design with the reflector 408 placed in front of the front end of the speaker 404 enclosure also works when there are listeners beside the wearer of the device. These other listeners can be to the side of the speaker enclosure 402, in which case, the speaker is also not pointed in the direction of these listeners. Again, the reflector 408, with its curved sound reflecting surface facing the front end of the speaker 404, can redirect the sound to the listeners instead of allowing the sound to dissipate away from them. In other words, the illustrated design allows for a sealed speaker 402 enclosure that may produce higher fidelity sound while redirected the sound with the reflector 408.

Although in the embodiments discussed above, the electronic wearable devices mimic common necklaces, it should be understood that the device can also be in the form of a shirt clip, tie clip, wrist band/watch, ankle band, head band, and the like that incorporates the interchangeable faceplates and, optionally, a sound reflector to direct sound from a speaker inside the device.

In another aspect of the disclosure, a sound event detection and response system is disclosed. Various embodiments of the sound event detection and response system can detect and recognize certain types of sound and, in response, initialize an emergency response. For example, an embodiment of the system can detect a dog barking and automatically ask a user if there is a problem. If the user fails to respond within a certain time frame, the system can automatically take one or more actions such as calling emergency services.

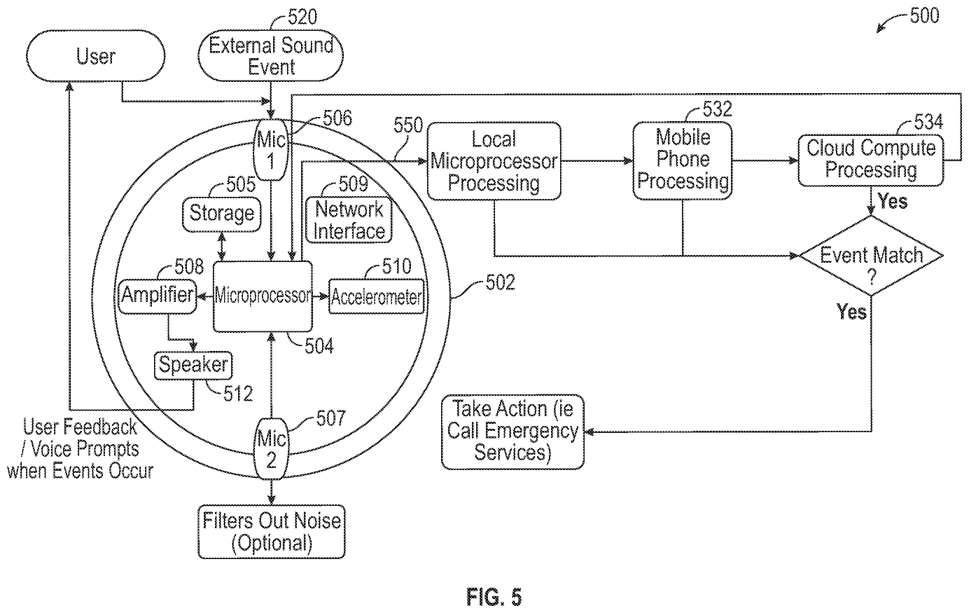

FIG. 5 is a diagram illustrating the exemplary components of a system of detecting sound and providing emergency responses, according to an embodiment of the disclosure. The system 500 of FIG. 5 includes a device 502 such as the electronic wearable device of FIG. 1. It should be understood that device 502 can be any other types of sound detecting devices. Device 502 can include a microprocessor 504, storage 505, one or more microphones 506, 507, an amplifier 508, I/O interface 509, an accelerometer 510, and a speaker 512. Some of these components may be optional and other components not illustrated in FIG. 5 can also be included in device 502.

When in use, the microphone 506 can capture external sound event 520 and audible input from a user 522. The sound event 520 can be any sound such as a dog barking, an alarm going off, sound of a car crash, a gun shot sound, etc. Audible input from a user can be a verbal response/instruction or any sound that is identifiable as made by a human. After the sound event 520 is captured by microphone 506, it is transmitted to the microprocessor 504, which analyzes the sound event to determine whether sound event 520 matches one of the pre-stored sounds. Microprocessor 503 can be any type of computer processor that is configured to receive signals and process the signals to determine a plurality of conditions of the operation of device 502. Processor 504 may also be configured to generate and transmit command signals, via I/O interface 509, to actuate local components such as microphones 506, 507, speaker 512. Processor 504 can also communicate with external devices such as a mobile phone 532 and/or cloud 534 over a network 550.

In one embodiment, the pre-stored sounds can include the different sounds from a variety of emergencies such as but not limited to car alarms, dogs barking sound, fire/smoke alarms, screaming, and gun shots. The pre-stored sounds can be stored in a database on a storage 505 accessible by the processor 504. The storage device 505 can be local to device 502 as in this embodiment or on a remote device connected to device 502 via a network as in other embodiments. For example, the pre-stored sounds can be stored on a cloud server. In one embodiment, different sounding alarms can be stored in the database with machine learning analysis to help detect variations of the sound frequency among other differences.

Storage device 505 can be configured to store one or more computer programs that may be executed by processor 504 to perform functions of the electronic device 502. For example, storage device 505 can be configured to process sound events, communicate with remote emergency service servers, and/or processing user input. Storage device 505 can be further configured to store data used by the processor 504. Storage device 505 can be non-transitory computer-readable medium storing instructions which, when executed, cause one or more processors to perform one or more methods, as discussed below. The computer-readable medium can include volatile or non-volatile, magnetic, semiconductor, tape, optical, removable, non-removable, or other types of computer-readable medium or computer-readable storage devices. The computer-readable medium can have computer instructions stored thereon, as disclosed. In some embodiments, the computer-readable medium may be a disc or a flash drive having the computer instructions stored thereon.

As illustrated in the embodiment of FIG. 5, the processing of the sound event 520 can be performed by the local processor 504, another device such as a mobile phone 532 connected to device 502, and/or remotely on a cloud 534. If the sound event 520 matches one of the pre-stored sounds in the database, the processor may initiate one or more responses. For example, if dog barking sound is captured by device 500 and is matched to the one of the pre-stored sounds in the database, the processor 504 can prompt the user whether there is a situation that would require calling emergency services. This can be done by playing a pre-stored message such as “would you like to call 911” from the speaker 512 on the device 500. If no response is received within a certain time frame (e.g., 10 seconds), the processor can be programmed to end communication or repeat the prompt. Device 500 can optionally provide a mechanism for the user to indicate that no action is needed. Such mechanism can be implemented via a user interface such as a touch or gesture interface.

In some embodiments, depending on the sound event captured, the disclosed system can provide different responses. For example, if the sound event is a car alarm going off and the user is unresponsive to a prompt, the device 502 can request emergency services. If the sound event corresponds to a car crash, the device 502 can send a message to an emergency contact of the user and/or call emergency services without first prompting the user for confirmation.

In some embodiments, the user can set which types of sound events to trigger a prompt or automatic response without prompt as well as what should be the response or action triggered, whether it is calling emergency services or contacting the user's emergency contact.

In some embodiments, the system may use correlate local sounds to improve its sound event recognition. For example, in the event of an earthquake, the device 502 can verify public information on recent earthquakes to see if one has occurred in close vicinity of device 502 when device 502 captures a sound event that indicates an earthquake. If verified, the system can prompt to see if the user of device 502 requires assistance or emergency services. As another example, the device 502 can verify if there is a report of an ongoing crime via police channels near the location when the sound of gun shots is captured. If verified, a request for emergency service can be sent automatically. In the examples provided above, the device 502 may also include a location determination component such as a GPS.

In some embodiments, the system can incorporate algorithms to help distinguish differences between different sound patterns. For example, it can recognize the sound of screaming laugher versus someone who is screaming for help and requires assistance. In some embodiments, the system can use machine learning (i.e., artificial intelligence) to learn new sound event that should trigger a response from the system. The machine learning can be supervised or unsupervised. In one example, if the user declines to request emergency assistance when prompted by the system, the system can automatically disassociate the sound event from an emergency. In some embodiments, this happens only after the user has repeatedly declined assistance in response to the same triggering sound event. Once a sound event is disassociated with an emergency, the system will no longer prompt the user or initiate a request for emergency assistance when the sound event is captured again. In contrast, if the user has requested emergency assistance when prompted after a sound event is detected, the system can automatically increase a confidence score being associated with the sound event. When the confidence score reaches a threshold, the system can automatically request emergency service without first prompting the user for confirmation.

Referring again to FIG. 5, the device 502 can also include a second microphone 507 for noise filtering.

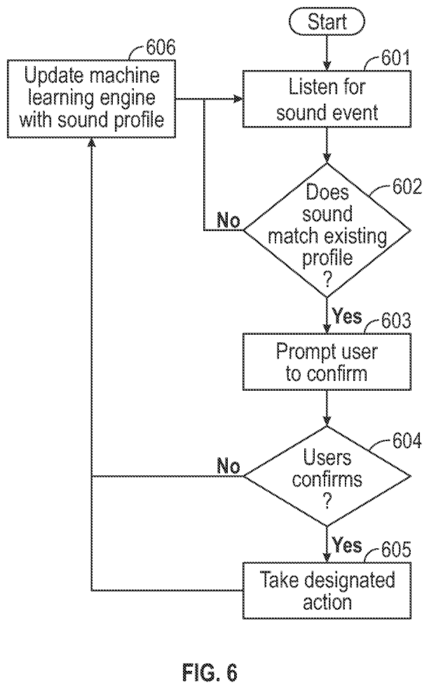

FIG. 6 is a flow chart illustrating the exemplary steps in the process of capturing a sound event and producing a corresponding response, according to an embodiment of the disclosure. First, the system listens for a sound event. (Step 601). The system determines whether the sound event matches one of the prestored sound events (e.g., existing sound profile). (Step 602). If there is no match, the system returns to step 601 and continues to listen for a sound event. If it is determined that there is a match, the system may prompt for user confirmation that assistance is requested. (Step 603). The system determines whether user confirmation is received. (Step 604). If user confirmation is received, the system can provide a response based on the detected sound event. (Step 605). Then, the machine learning engine of the system is updated with the sound event being a match with one of the existing sound profiles. (Step 606). If no user confirmation is received, the machine learning engine of the system is also updated accordingly. (Step 606). Once the machine learning engine is updated, the systems returns to listening for a new sound event. (Step 601).

All of the methods and tasks described herein may be performed and fully automated by a computer system. The computer system may, in some cases, include multiple distinct computers or computing devices (e.g., physical servers, workstations, storage arrays, cloud computing resources, and mobile devices, etc.) that communicate and interoperate over a network to perform the described functions. Each such computing device typically includes a processor (or multiple processors) that executes program instructions or modules stored in a memory or other non-transitory computer-readable storage medium or device (e.g., solid state storage devices, disk drives, etc.). The various functions disclosed herein may be embodied in such program instructions or may be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid-state memory chips or magnetic disks, into a different state. In some embodiments, the computer system may be a cloud-based computing system whose processing resources are shared by multiple distinct business entities or other users.

Depending on the embodiment, certain acts, events, or functions of any of the processes or algorithms described herein can be performed in a different sequence, can be added, merged, or left out altogether (e.g., not all described operations or events are necessary for the practice of the algorithm). Moreover, in certain embodiments, operations or events can be performed concurrently, e.g., through multi-threaded processing, interrupt processing, or multiple processors or processor cores or on other parallel architectures, rather than sequentially.

The elements of a method, process, routine, or algorithm described in connection with the embodiments disclosed herein can be embodied directly in hardware, in a software module executed by a processor device, or in a combination of the two. A software module can reside in RAM, flash memory, ROM, EPROM, EEPROM, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Although embodiments of this disclosure have been fully described with reference to the accompanying drawings, it is to be noted that various changes and modifications will become apparent to those skilled in the art. Such changes and modifications are to be understood as being included within the scope of embodiments of this disclosure as defined by the appended claims.

What is claimed is:

1. An electronic device comprising:
a user interface;
a microphone configured to capture an ambient sound event;
a storage configured to store a plurality of pre-identified sound events;
a processor connected to the microphone, the storage, and the user interface, the processor is configured to
determine whether the ambient sound event matches at least one of the plurality of pre-identified sound events;
generate a prompt via the user interface for a user to confirm that a response is needed;
determine whether to initiate a response based on the user's response to the prompt.

2. The electronic device of claim 1, wherein each of the plurality of pre-identified sound events is associated with an emergency.

3. The electronic device of claim 2, wherein the plurality of pre-identified sound events comprise one or more of: an alarm sound, car crash sound, animal bark, fire arm sound, and scream by a person.

4. The electronic device of claim 1, wherein the processor determining whether the ambient sound event matches at least one of the plurality of pre-identified sound events comprises comparing a sound signal of the ambient sound event and that of each of the plurality of pre-identified sound events.

5. The electronic device of claim 1, wherein the processor generating the prompt via the user interface for a user to confirm that a response is needed comprises generating a message over the speaker.

6. The electronic device of claim 5, wherein the processor is configured to monitor user responses for a period of time after the prompt is generated.

7. The electronic device of claim 1, wherein the processor determining whether to initiate a response based on the user's response to the prompt comprises initiating a response if the user's response confirms an emergency.

8. The electronic device of claim 1, wherein the processor determining whether to initiate a response based on the user's response to the prompt comprises analyzing correlated information in the absence of a user's response to determine if a response is to be initiated.

9. The electric device of claim 8, wherein a response is initiated if the correlated information supports a need to initiate the response.

10. The electric device of claim 9, wherein the ambient sound matches to an earthquake sound and the correlated information comprising public information of an earthquake in the vicinity where the ambient sound is detected.

11. A computer implemented method comprising:
capturing an ambient sound event;
determining whether the ambient sound event matches at least one of a plurality of pre-identified sound events stored in a computer storage;
generating a prompt via the user interface for a user to confirm that a response is needed;
determining whether to initiate a response based on the user's response to the prompt.

12. The computer implemented method of claim 11 wherein each of the plurality of pre-identified sound events is associated with an emergency.

13. The computer implemented method of claim 12, wherein the plurality of pre-identified sound events comprise one or more of: an alarm sound, car crash sound, animal bark, firearm sound, and scream by a person.

14. The computer implemented method of claim 11, wherein determining whether the ambient sound event matches at least one of the plurality of pre-identified sound events comprises comparing a sound signal of the ambient sound event and that of each of the plurality of pre-identified sound events.

15. The computer implemented method of claim 11, wherein generating the prompt via the user interface for a user to confirm that a response is needed comprises generating a message over the speaker.

16. The computer implemented method of claim 15, further comprising monitoring user responses for a period of time after the prompt is generated.

17. The computer implemented method of claim 11, wherein determining whether to initiate a response based on the user's response to the prompt comprises initiating a response if the user's response confirms an emergency.

18. The computer implemented method of claim 11, wherein determining whether to initiate a response based on the user's response to the prompt comprises analyzing correlated information in the absence of a user's response to determine if a response is to be initiated.

19. The computer implemented method of claim 18, wherein a response is initiated if the correlated information supports a need to initiate the response.

20. The computer implemented method of claim 19, wherein the ambient sound matches to an earthquake sound and the correlated information comprising public information of an earthquake in the vicinity where the ambient sound is detected.
